(19) United States
(12) Patent Application Publication
(10) Pub. No.: US 2021/0264459 A1
(43) Pub. Date: Aug. 26, 2021

(54) A METHOD OF LOYALTY EXCHANGE TRANSACTION BY USING BLOCKCHAIN FOR REWARD POINT EXCHANGE

(71) Applicant: ASIA TOP LOYALTY LIMITED, Kowloon, Hong Kong (CN)

(72) Inventor: Pak Keung CHEN, Kowloon, Hong Kong (CN)

(21) Appl. No.: 17/261,290

(22) PCT Filed: Jul. 17, 2019
(86) PCT No.: PCT/IB2019/056091

§ 371 Date: Jan. 19, 2021

(30) Foreign Application Priority Data
Jul. 19, 2018 (CN) 18109386.3

(51) Int. Cl. G06Q 30/02; G06Q 20/36; H04L 9/06

(52) U.S. Cl. CPC G06Q 30/0226; G06Q 20/363; H04L 2209/56; H04L 2209/38; H04L 9/0618

(57) ABSTRACT

This invention involves with A method of loyalty exchange transaction by using blockchain for reward point exchange, the system has created an “open-loop and decentralized” loyalty platform using blockchain, which provides instant redemption and exchange capabilities across multiple loyalty point programs or currencies. The user only needs to log into the wallet to manage all their different accounts and would not have to remember multiple conversation rates, restrictions, and redemption rules. Also, the system allows both large and local partners to be added seamlessly to the system to create an ecosystem with LPOs, loyalty members, institutional buyers and merchants all benefiting from the technology with much lower operation costs to run, and under standardized rules which are easily understood.

### BACKGROUND OF THE INVETION

### Field of Invention

This invention involves with loyalty programs, especially involves method of loyalty exchange transaction by using blockchain for reward point exchange.

### BACKGROUND OF THE INVENTION

Almost USD 500 billion′ worth of retail loyalty points that could be spent on flights, holidays, rented cars or groceries are sitting idle in forgotten cards in wallets.

In the United States, an average household enrols in over 25 Loyalty Program Operators (LPO)—creating a mammoth task for anyone to manage all the related accounts and passwords. Customers are understandably frustrated as they often do not have enough points to redeem the goods they want. Over time, these points would expire and become worthless to the consumer.

Loyalty program operators also make it difficult for members to transfer points between one another and set up hurdles such as “blackout dates” to make it hard for customer to use their points whenever they want. Over time, points would be purged and the program owners benefit from the forgone points.

### SUMMARY OF THE INVETION

For the defect or deficiency of the existing technology, this invention desires to resolve the following technical problem, namely this invention will provide a method of loyalty exchange transaction by using blockchain for reward point exchange, to create a platform based on Blockchain, which easily tracks and verifies the number of tokens being traded or used, also to create an ecosystem by connecting different LPOs, merchants, institutional buyers and customers with a common digital asset.

A method of loyalty exchange transaction by using blockchain for reward point exchange, a system consists of:

a wallet which allows versatile access to the user's various loyalty points, the said various loyalty points are deposited in external loyalty platform which is hold by merchants,

specified tokens by system which is used in wallet and liquidity market as the native token for all interactions between users and merchants,

a loyalty central which allows the converting between various loyalty points and specified token,

user login his wallet to raise an exchange request to loyalty central for exchanging between the loyalty points and the specified tokens.

As the further improvement of this invention, the work flow of an exchange transaction is as follow:

Step 1. user logins his wallet by sending authentication to the loyalty central,

Step 2. the loyalty central passes authorization of user through external loyalty platform authorization service to external loyalty platform and retrieve data of loyalty points from external loyalty platform for returning to the user's wallet,

Step 3. user raises an exchange transaction to the loyalty central by wallet, the loyalty central checks the rate between the specified token and the designated loyalty point and verified the balance of user's specified tokens,

Step 4. the loyalty central deduct specified tokens according to said rate and sends exchange for loyalty points issuing request to the external loyalty platform; or the loyalty central sends exchange for loyalty points deducting request to the external loyalty platform according to said rate and raise specified tokens,

Step 5. the external loyalty platform issues loyalty points to user.

As the further improvement of this invention, the system also consist of a multi-currency exchange engine which has access to exchange between specified token, universal reward point and fiat money.

As the further improvement of this invention, the said multi-currency exchange engine includes a integration API by which every external loyalty platform can connect to the multi-currency exchange engine.

As the further improvement of this invention, in Step 3 to Step 4, the multi-currency exchange engine enrolls in the exchange transaction as follow:

Step 3. user raises an exchange transaction to the loyalty central by wallet, the loyalty central checks the rate between the specified token, intermediate currency and the designated loyalty point and verified the balance of user's specified tokens,

Step 4. the loyalty central deduct specified tokens according to said rate, sends exchange for intermediate currency request to the multi-currency exchange engine, acquires intermediate currency, and pay intermediate currency to the external loyalty platform for loyalty points issuing.

As the further improvement of this invention, the specified tokens are a blockchain token which follow standard such as ERC20 that will be created during the token generation event period.

As the further improvement of this invention, Up to 1,000,000,000 specified tokens will be issued during that period.

As the further improvement of this invention, the loyalty central is based on blockchain which enables a ledger of transactions to be shared across a network of participants, when loyalty points are issued, the specified token is created and assigned to that transaction; the specified tokens are grouped into blocks and distributed across the network, updating every ledge at once; new transaction blocks are validated and linked to older blocks, creating a strong, secure and verifiable record of all transactions, without the need for intermediaries or centralized database.

Beneficial effects of this invention: the system creates an “open-loop and decentralized” loyalty platform using blockchain, which provides instant redemption and exchange capabilities across multiple loyalty point programs or currencies. Instead of having to remember multiple account login and password details, or produce a physical card for redemption, the user needs only to log into his wallet to manage all his different accounts. With only one wallet, user would not have to remember multiple conversation rates, restrictions, and redemption rules. This essentially creates an ecosystem with LPOs, loyalty members, institutional buyers and merchants all benefiting from our blockchain technology with much lower operation costs to run, and under standardized rules which are easily understood.

### BRIEF DESCRIPTION OF THE DRAWINGS

FIG. 1 shows the authorization and authentication process between the wallet and the external loyalty Points systems;

FIG. 2 shows the transection process between user, the loyalty central and the external loyalty platform;

FIG. 3 shows the transection process between user, the loyalty central, the multi-currency exchange engine and the external loyalty platform.

### DETAIL DESCRIPTION OF THE INVENTION

In the following, this invention will be further illustrated with the description of attached diagrams and specific embodiments.

The wallet

To allow versatile access to the user's various loyalty points, specified tokens and fiat money, we designed easy-to-use mobile native application wallet (initially developed for Android and iOS devices using Swift and Kotlin or technologies similar to that respectively for the best end-user experience in each of the distinct mobile platforms). It will allow users to have trust-less access to their crypto assets. For this scheme to work we will employ standard of BIP-32 or similar standard to generate as many subwallets per loyalty point as user wishes to use and also standard of BIP-39 or similar standard to implement simple and secure way of backing up the randomness used to generate private keys for all the supported cryptocurrencies. User is allowed to see the BIP-39 compatible or similar standard mnemonics set encrypted with user's password. That same mnemonics set encrypted using AES algorithm with the user's password hardened with the algorithm PBKDF2 and fragmented to many pieces using Shamir's Secret3 sharing protocol will be also securely stored across many data centers/locations.

As there are distinct use cases and users with their habits of using browser-based web applications for any services offered out there, it is anticipated there will be also users not willing to utilize mobile native application to have access to the wallet and instead they would prefer to use their browsers for that purpose. In light of these requirements, the same functionality as laid out in this document with at least same level of security consideration would be also offered as HTML responsive web-based application. Generally the backend and blockchain processes would be shared and only different user interface would be used for different needs of different user profiles.

Access to the wallet will be guarded not only by the user's password or PIN code but also with the user's permission by the sophisticated biometric factors, mainly facial recognition algorithms. Technologies like Face++ or ZoOm matured over years and reached the level of accuracy that make them now trusted by the reputable financial institutions and organizations as a means of user's authentication of access to their private financial products and services. Using technologies like that the users will conduct registration process in which his/her biometric factors will be scanned, digitized and hashed to be usable as the factor for the comparison and authentication in the future login attempts to the application. Hashed data like that can be safely stored in the encrypted form, digitally signed by the user on the loyalty central for the future usage in the authentication process.

The Specified Tokens

The specified tokens are token which comply to standard such as ERC20 that will be created during the token generation event period. Up to 1,000,000,000 specified tokens will be issued during that period.

The specified tokens will be used in the wallet and liquidity market as the native token for all interactions between users and merchants. The specified tokens can be accessed by using any wallet service that supports ERC20-compliant tokens, such as MyEtherWallet, Parity, and the official wallet.

The specified tokens design will be based on the ultra-secure and respected by the security community OpenZeppelin framework for smart contracts development. For the integrated development and QA environment the latest industry standard of Truffle Suite is used. And the latest version of smart contracts programming language—Solidity is utilized.

The Multi-Currency Exchange Engine

For the system to have access to the liquid source of the loyalty points, the exchange engines integration is introduced. Purpose of this exchange is to convert loyalty points to the specified tokens and later to fiat money. It can be accomplish by utilizing the Bancor Network with ShapeShift or Changelly or other similar multi-crypto exchanges with the API for the external integration.

The specified tokens can be also added to the Bancor Network protocol immediately creating liquid market for them without asking any centralized exchanges for permission.

For the end user to allow access to any loyalty points platform directly from the wallet we will design REST-based integration API which every other external loyalty point system that wants to allow their users to have the access to their points would need to implement and integrate.

The Loyalty Central

The loyalty central is the core of the system. Tightly coupled with the wallet as its user-facing interface offers seamless access to all of the platform features, including hasslefree management of users loyalty points within the system but also any other loyalty points platform integrated into the system.

a) External Loyalty Points System Integration

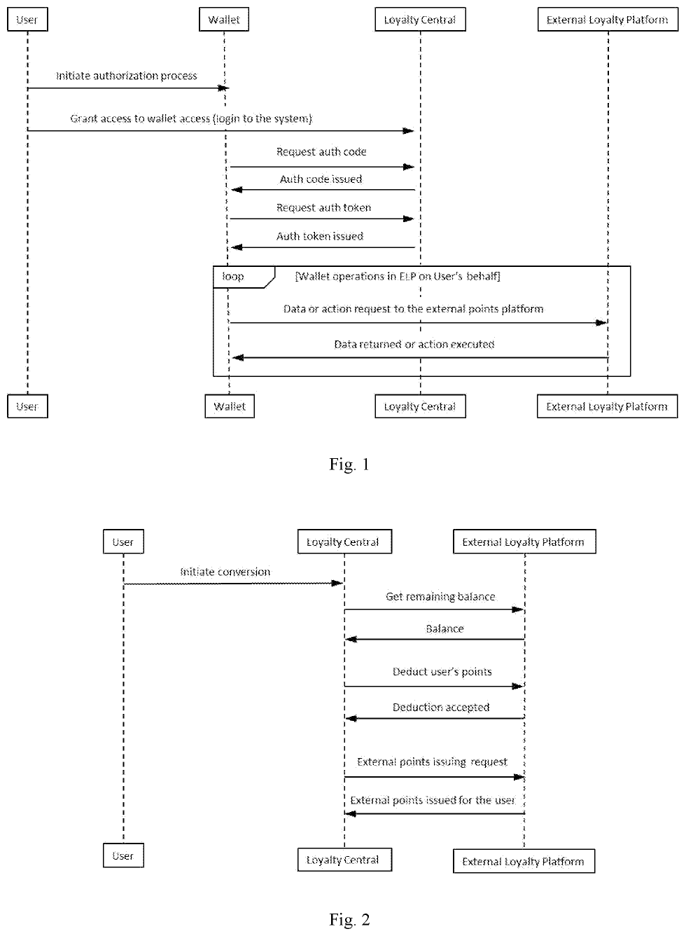

For the end user to allow access to any loyalty points platform directly from the wallet, REST-based integration API which every other loyalty point system that wants to allow their users to have the access to their points would need to implement and integrate. The authorization and authentication process between the wallet and the external loyalty Points systems (ELP) would follow the standardized OAuth220 protocol as FIG. 1.

b) Converting ELP Points into Specified Tokens

For the end user the smoothest experience is offered by the specified tokens itself, as these tokens could be spend directly at any participating merchant site hence it is envisaged that users would readily convert their proprietary loyalty points at external loyalty points system into the specified tokens. To allow those operations to happen, the exchange protocol that employs the integration protocol between the ELP, external exchanges where the specified token will be traded and also the financial/fiat integration flow is introduced. The overview of that integration mechanism can be observed on the FIG. 2.

It is worth noting that some merchants would like to accept the specified token as a means of payment or as a means of the bonuses redemption but they would not like to be exposed to the exchange rate risk, hence would prefer to convert these specified tokens to the local currency. As the multicurrency exchange engine developed as part of the loyalty central offer quick conversion between crypto tokens and the fiat currencies we can and we will offer that service to our merchants.

c) Converting Specified Tokens into ELP Points

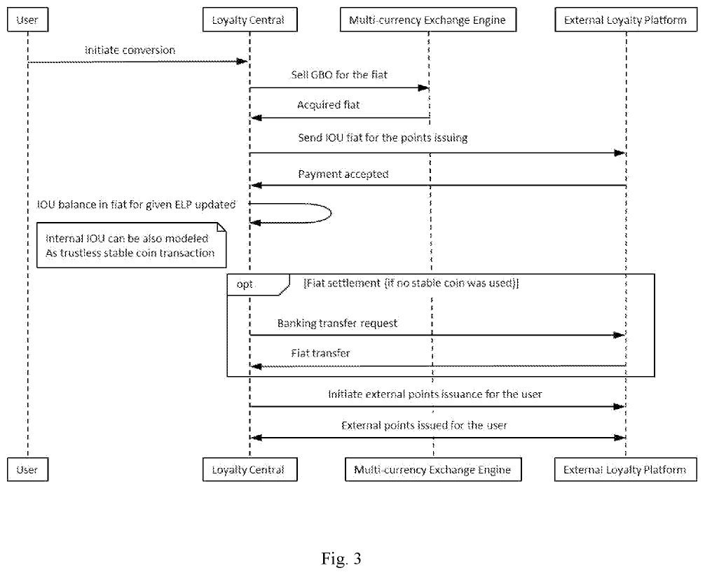

It is also envisioned that some users would like to convert their specified tokens holdings into the external loyalty proprietary points, for example if there are special promotions at the given merchant for the holders of that merchant own points. For that process to happen smoothly directly from the wallet, the protocol and operations reverse the above mentioned flow. The details of this protocol can be reviewed on the FIG. 3

Analytics, AI, BigData

With the vast amount of users' data to which the system has access to (spending habits and patterns, geographical locations, wealth levels, gender, age group etc), these data could be utilized and put to work for the purposes beneficial to both data-holders, merchants and also other platform stakeholders. On the other hand the system with its interconnectivity with various external exchange platforms and also its own internal exchange capabilities is able to monitor and discover interesting arbitrage and other trading opportunities that could be offered also own platform users.

To be able to handle these huge volumes of BigData and on the other hand to use machine learning and other Artificial Intelligence techniques on the BigData and also coining in real-time transactional data (exchange rates, trades executed in real-time etc) strong and reliable technology stack is a must. One of the tech stack that is able to handle both type of demands at the same time and is accessible as an open-source, hence for very reasonable pricing and with huge community of developers behind it is Elastic Stack with its components of: Elasticsearch (search and analytics engine), Logstash (data enrichment, cleansing, real-time transformation, aggregation and mutation), Kibana (visualization tool, drill down data explorer and discoverer) and Machine Learning (artificial intelligence engine that can spot the insights and patterns that casual human observer might miss). More elaborate introduction to each of these components can be reviewed following the links from the footer. What is worth noting here is that big cloud companies like Amazon AWS have dedicated cloud services based directly on the Elasticsearch and the related component hence the server-side infrastructure setup can be both cheap and reasonably easy and time-efficient to implement and for petabyte-scale data sources.

1. A method of loyalty exchange transaction by using blockchain for reward point exchange, wherein, a system consist of:
a wallet which allows versatile access to the user's various loyalty points, the said various loyalty points are deposited in external loyalty platform which is hold by merchants;
specified tokens by system which is used in wallet and liquidity market as the native token for all interactions between users and merchants;
a loyalty central which allows the converting between various loyalty points and specified token;
user login his wallet to raise an exchange request to loyalty central for exchanging between the loyalty points and the specified tokens.

2. The method of loyalty exchange transaction by using blockchain for reward point exchange of claim 1, wherein, the work flow of an exchange transaction is as follow:
Step 1. user logins his wallet by sending authentication to the loyalty central;
Step 2. the loyalty central passes authorization of user through external loyalty platform authorization service to external loyalty platform and retrieve data of loyalty points from external loyalty platform for returning to the user's wallet;
Step 3. user raises an exchange transaction to the loyalty central by wallet, the loyalty central checks the rate between the specified token and the designated loyalty point and verified the balance of user's specified tokens;
Step 4. the loyalty central deduct specified tokens according to said rate and sends exchange for loyalty points issuing request to the external loyalty platform; reversely, the loyalty central sends exchange for loyalty points deducting request to the external loyalty platform according to said rate and raise specified tokens;
Step 5. the external loyalty platform issues loyalty points to user.

3. The method of loyalty exchange transaction by using blockchain for reward point exchange of claim 1, wherein, the system also consist of a multi-currency exchange engine which has access to exchange between specified token, universal reward point and fiat money.

4. The method of loyalty exchange transaction by using blockchain for reward point exchange of claim 3, wherein, the said multi-currency exchange engine includes a integration API by which every external loyalty platform can connect to the multi-currency exchange engine.

5. The method of loyalty exchange transaction by using blockchain for reward point exchange of claim 3, wherein, in Step 3 to Step 4, the multi-currency exchange engine enrolls in the exchange transaction as follow:
Step 3. user raises an exchange transaction to the loyalty central by wallet, the loyalty central checks the rate between the specified token, intermediate currency and the designated loyalty point and verified the balance of user's specified tokens,
Step 4. the loyalty central deduct specified tokens according to said rate, sends exchange for intermediate currency request to the multi-currency exchange engine, acquires intermediate currency, and pay intermediate currency to the external loyalty platform for loyalty points issuing; reversely, the loyalty central sends exchange for loyalty points issuing and external loyalty platform sells out loyalty points for intermediate currency, then the loyalty central sends exchange for intermediate currency request to the multi-currency exchange engine for raising user's specified tokens.

6. The method of loyalty exchange transaction by using blockchain for reward point exchange of claim 1, wherein, the specified tokens are a blockchain token which follow standard such as ERC20 that will be created during the token generation event period.

7. The method of loyalty exchange transaction by using blockchain for reward point exchange of claim 5, wherein, Up to 1,000,000,000 specified tokens will be issued during that period.

8. The method of loyalty exchange transaction by using blockchain for reward point exchange of claim 1, wherein, the loyalty central is based on blockchain which enables a ledger of transactions to be shared across a network of participants, when loyalty points are issued, the specified token is created and assigned to that transaction; the specified tokens are grouped into blocks and distributed across the network, updating every ledge at once; new transaction blocks are validated and linked to older blocks, creating a strong, secure and verifiable record of all transactions, without the need for intermediaries or centralized database.
